(19) United States
(12) Patent Application Publication
(10) Pub. No.: US 2007/0168555 A1
(43) Pub. Date: Jul. 19, 2007

(54) Efficient multicast call setup method and system

(76) Inventor: Jheroen P. Dorenbosch, Paradise, TX (US)

Correspondence Address: MOTOROLA, INC., 1303 EAST ALGONQUIN ROAD, IL01/3RD, SCHAUMBURG, IL, 60196, US

(21) Appl. No.: 11/333,977

(22) Filed: Jan. 18, 2006

(51) Int. Cl. G06F 15/16

(52) U.S. Cl. 709/245

(57) ABSTRACT

A system (100) and method (200) of setting up a multicast session in a wireless system having at least one access point serving a plurality of wireless terminals that are members of a multicast group can include collecting (202) a member set representing members of the multicast group and receiving (206) a multicast packet by the access point. The method further determines (208) a target set of terminals receiving the multicast packet. If a number of terminals in the target set is greater or equal to a threshold, then the multicast packet is multicast (214) to a multicast address. If the number of terminals in the target set is less than the threshold and greater than zero, then a copy of the multicast packet is unicast (216) to the unicast address of each terminal. The method can also suppress (218) the multicast packet if the number of terminals is zero.

### FIELD OF THE INVENTION

This invention relates generally to multicast methods and systems, and more particularly to an efficient call set up method and system using both multicast and unicast transmissions.

### BACKGROUND OF THE INVENTION

For conferencing, distribution of streaming media, for dispatch and for public safety it is important to efficiently support multicast sessions. With multicast, a controller or transmitter can send or broadcast the same information to many receivers. In contrast, with unicast a controller or transmitter sends or broadcasts an individual copy of the information to one or more receivers. For dispatch calls and for many other applications it is important that sessions can be set up rapidly. For example, consideration is being given to performing dispatch in an architecture where all dispatch calls—including those between just two participants—would use IP multicast. Multicast architectures are elegant, but can not easily be applied in 3G and 4G wireless internet protocol (IP) systems like 802.11, 802.16 and Flarion. In such systems downlink multicast is many times more expensive and cumbersome than unicast. Multicast cost is high because it is difficult to use acknowledged transmission, power management, code selection and header compression.

An additional difficulty in Mobile IP (MIP) systems is that a controller of a session can't easily determine where wireless terminals (WTs) that participate in session are attached. In particular, it becomes difficult and expensive for the controller to know how many WTs are attached at a particular transmitter. Transmitters in these systems can behave like IP switches or bridges (in 802.11) or like routers such as Flarion Radio Routers. Accordingly, systems and methods of determining whether to use a multicast or unicast downlink transmission on a particular transmitter when transmitting to a multicast group can improve overall performance and cost.

### SUMMARY OF THE INVENTION

Embodiments in accordance with the present invention can provide a system and method to make a choice between unicasting or multicasting a packet when transmitting the packet to a multicast group. Note that the packet normally belongs to a transmission sequence that contains multiple packets, where the transmission of multiple packets may be part of a session of the multicast group. A typical example of such a session is a dispatch session in a wireless network where the multicast group consists of the participants in the dispatch session and where the voice of the each talker is transmitted to the multicast group as a sequence of packets, preferably using the well-known Voice over IP (VoIP) protocol.

In a first embodiment of the present invention, a method of sending a multicast packet in a wireless system is illustrated having at least one access point serving a plurality of wireless terminals that are members of a multicast group. Note, an access point can be or include a transmitter or be a transmitter for a basestation in a cellular network. The method can include the steps of collecting a member set representing members of the multicast group that are being served, the member set including a unicast address for each wireless terminal in the set among the plurality of wireless terminals and receiving a multicast packet by the access point. The method can further determine a target set of served wireless terminals that are members of the multicast group that will receive the multicast packet, multicast the multicast packet on a downlink from the access point to a multicast address if a number of wireless terminals in the target set is greater or equal to a threshold, and unicast a copy of the multicast packet on the downlink to the unicast address of each of the wireless terminals in the target set if the number of wireless terminals in the target set is below the threshold. The method can also suppress the multicast packet on the downlink if the number of wireless terminals in the target set is zero.

The method can collect the member set representing members of the multicast group by detecting a session setup request for a multicast session directed to one or more members of the multicast group. The session setup request may, for example, be a Session Initiation Protocol (SIP) INVITE message directed to each of the one or more members of the multicast group, where the SIP INVITE specifies that the session will send packets to the multicast group. The method can further join a multicast distribution tree for the multicast group by the access point in response to the detecting of the session setup request for the multicast session. The access point can generate a protocol independent-sparse mode message for joining a multicast group in response to the detecting of the session setup request for the multicast session. This manner of setting up of the multicast distribution tree can be started before a wireless terminal has asked for it, and thereby accelerating the setup of the session. The method can also store multicast group member sets for each wireless terminal in the plurality of wireless terminals served by the access point. The method can further forward one or more multicast group member sets for one or all wireless terminals to an adjacent access point to enable a proactive joining by the adjacent access point to a multicast distribution tree for the multicast group. The proactive joining can occur in response to a receipt by the adjacent access point of a location update from a wireless terminal in the target set.

In a second embodiment of the present invention, an access point serving a plurality of wireless terminals that are members of a multicast group can include a wireless transceiver and a processor coupled to the wireless transceiver. The processor or access point can be programmed to perform all the steps previously described above with respect to the method.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a wireless communication system in accordance with an embodiment of the present invention

FIGS. 2 through 3 are flow charts of a method for unicast versus multicast determination in accordance with embodiments of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

The present invention includes permitting a system to make a choice between unicasting and multicasting a packet when transmitting the packet to a multicast group. When a originator of a packet specifies the use of multicast, a wireless Access Point (AP) or transmitter can still chose between using replicated unicast and multicast in the cell or sectors it supports. Individual APs make this decision independently; based on a cost comparison between unicast and multicast. The system may include a single AP.

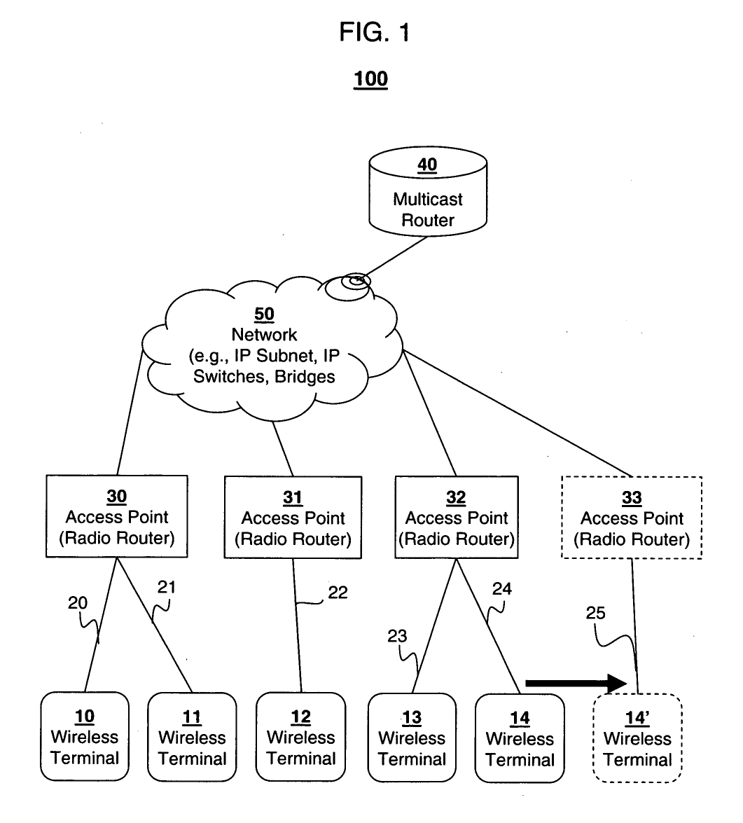

Referring to FIG. 1 a block diagram of a wireless internet protocol (IP) communication system 100 is shown. The communication system 100 serves wireless terminals (WTs) 10-14 via one or more Access Points 30-32. Access Points 30-32 are connected to a network 50. The network supports multicast, preferably through the use of one or more multicast IP routers 40. Multicast packets are routed between routers in the network using one of many well-known Multicast Routing Protocols, such as Protocol Independent Multicast-Sparse Mode (PIM-SM). The network 50 also supports unicast.

APs 30-32 may themselves be multicast routers (e.g. IP multicast Routers) each serving one or more wireless cells or sectors (not shown). Each such AP normally will service a single cell. APs 30-32 can also be IP switches or bridges (E.g. 802.11 Access Points). Several such APs can be connected to a multicast router 40 via a common IP subnet. The protocols used in the cells or sectors support unicast as well as multicast, preferably through the use of IP unicast and multicast. Preferably each wireless sector is a separate IP subnet, but alternatively multiple sectors serviced by the same Access Point may form a single IP subnet. APs 30-32 may support one or more WTs 10-14 by sending information to the WTs and by receiving information from the WTs over wireless links 20-24. The information may be bits, bytes, packets, messages, or steams of bits, bytes, packets or messages. Below we will refer to such information as packets.

APs may serve WTs by sending and receiving packets using unicast or multicast. WTs 10-14 will each have one or more unique identifiers, preferably layer 3 IP addresses, and a unique layer 2 address, such as a MAC address. An AP uses these unique addresses to send or unicast downlink packets to individual WTs. Unique identifiers or unicast addresses are also used in an uplink packet and enable an AP to determine which of the WTs in the cell has sent the packet.

A WT 10-14 can belong to, or be a member of zero or more multicast groups, with each multicast group represented by a group multicast address or group address. An AP uses a group address to multicast downlink packets to all WTs in the cell that belong to the group. A WT can use a group address to multicast uplink packets to the group.

An AP 30-32 can receive a multicast packet in different ways. The AP can receive a multicast packet from the network. Packets received from the network may be received from the network 50 via a multicast router 40 or from other APs via a common network, such as a common, real or virtual subnet. If the AP is itself a multicast router it will receive the packet on its network interface for transmission on one or more interfaces connected to the sectors or cells served by the AP. If the AP is a switch connected to a multicast router 40 via a common subnet, the AP will receive the packet on its subnet interface for transmission on the sectors or cells served by the AP. The AP can also receive a multicast packet that has been transmitted by one of the served WTs on the uplink. The AP can determine the ID of the sending WT by inspection of the layer 2 or layer 3 source address of the packet. The AP then forwards the received packet to its wired interface with the network 40. If the AP is a router, it may use an interface designated to be part of the multicast distribution tree for the multicast group, and the multicast router 40 may forward the packet over the network 50. If the AP is a switch, it forwards the packet to its common subnet interface. In the latter case, all other APs on the common subnet will also receive the multicast packet on their subnet interface.

In general, in wired networks all hosts connected to a common subnet will see all packets transmitted on the subnet by any other host. Hence when one host transmits a multicast packet onto the subnet, there is no need to retransmit that packet on the same subnet. This is no longer true in wireless systems. For example, if WT 14 transmits a multicast packet on the uplink 24 and the AP 32 receives the packet, there is no guarantee that other WTs 12-13 in the same cell will be able to receive the multicast packet. For this reason it is customary that AP will transmit or echo on the downlink any multicast packet received on the uplink. This is done to give any served WTs that are members of the multicast group an opportunity to receive the multicast packet. Similarly, customarily, other APs connected to a common subnet with the AP that receives the multicast packet on the uplink will receive the packet on the subnet interface and transmit or echo it on the downlink to give any served member WTs an opportunity to receive the multicast packet.

Normally downlink multicast from an AP in one sector is independent from downlink multicast in other sectors; downlink multicast in the one sector is normally only received by WTs in that sector. In rare cases, downlink multicast is coordinated across multiple sectors serviced by a single AP; downlink multicast from the AP is intended to be received by the WTs in any one of the coordinated multiple sectors. Below we will use the term cell for a cell or sector with independent multicast as well as for multiple sectors with coordinated multicast.

For downlink unicast transmission of a packet, APs and WTs use additional information e.g. from acknowledgements, signal quality reports and other feedback to estimate the link quality of the wireless link between an AP 30-32 and a WT 10-14. The link quality estimates can then be used to optimize the downlink unicast transmission. Using well-known methods, APs can chose an optimal combination of power, coding rate and repeats to minimize one or more of the total transmit power, the total number of symbols or slots and the total time needed to transmit one or more specific packets to a specific WT. This optimization reduces the cost of unicasting the packet. For downlink multicast transmission of a multicast packet, APs normally use transmission parameters, such as power, coding rate and repeats that is sufficient for the packet to be received by all member WTs with sufficient reliability. Often the AP simply assumes that the WT is at or near the edge of the coverage region and uses a predetermined combination of high power and low coding rate. Clearly, in most cases multicasting a packet to a single WT has a higher cost than unicasting the same packet to the same WT. However, multicasting a packet to a multiple member WTs may or may not be more costly than unicasting the same packet to the same WTs.

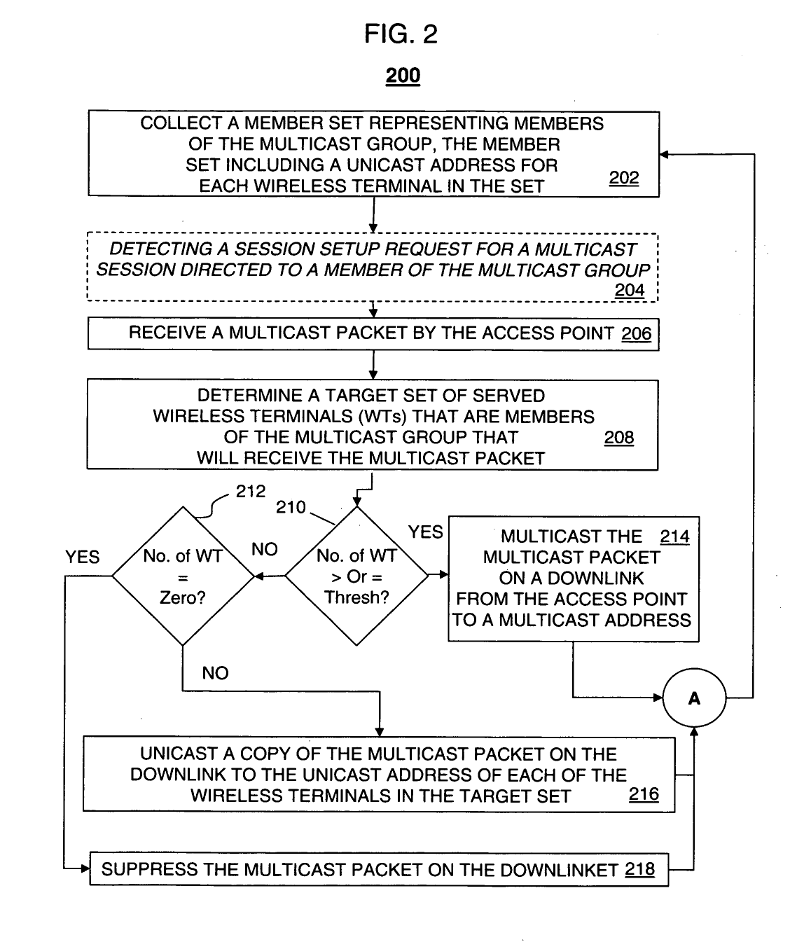

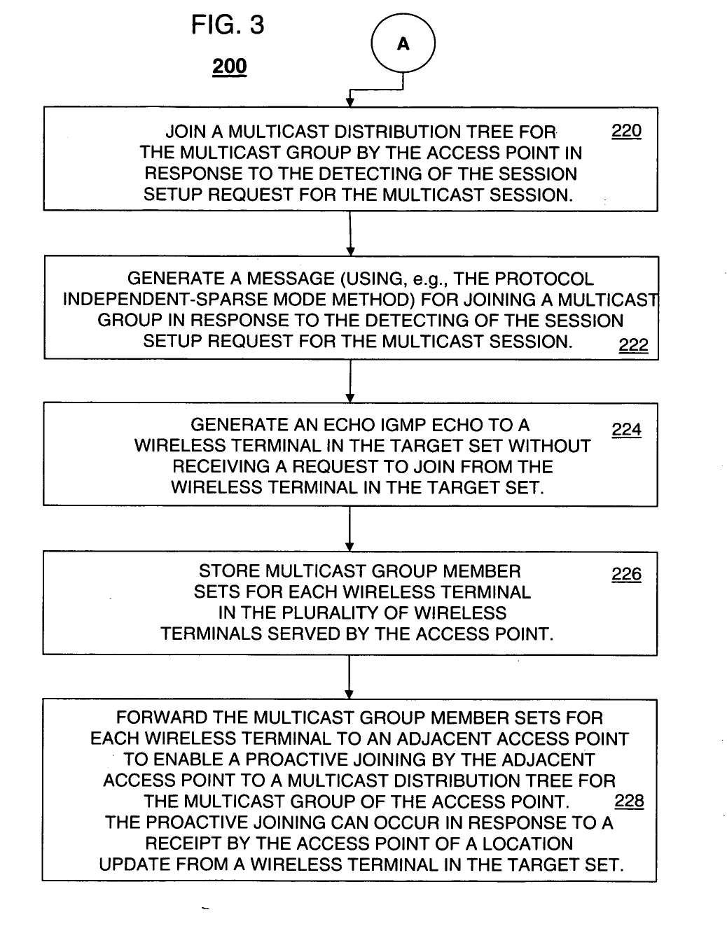

Referring to FIG. 2, a flow chart illustrating a method 200 of setting up a multicast session in a wireless system having at least one access point serving a plurality of wireless terminals that are members of a multicast group. When describing the method 200, reference will be made to FIGS. 1-3, although it must be noted that the method 200 can be practiced in any other suitable system or device. Moreover, the steps of the method 200 are not limited to the particular order in which they are presented in FIGS. 2 and 3. The inventive method can also have a greater number of steps or a fewer number of steps than those shown in FIGS. 2 and 3. The method 200 can include the step 202 of collecting a member set representing members of the multicast group that are being served, the member set including a unicast address for each wireless terminal in the set among the plurality of wireless terminals and receiving at step 206 a multicast packet by the access point. The packet may be received from a network or from a member that is being served. The method 200 can collect the member set representing members of the multicast group by optionally detecting at step 204 a session setup request for a multicast session directed to a member of the multicast group. The method 200 can further determine a target set of served wireless terminals that are members of the multicast group that will receive the multicast packet at step 208. Determination of the target set takes into account whether the packet is received from a network or from a member in the member set. If the packet is received from a member in the member set, the member can be removed from the target set for the transmission of this packet from this access point since the member does not need to receive a copy of the packet it just sent. If a number of wireless terminals in the target set is greater or equal to a threshold at decision block 210, then the method can multicast the multicast packet on a downlink from the access point to a multicast address at step 214. If the number of wireless terminals in the target set is less than the threshold and greater than zero at decision block 212, then the method can unicast a copy of the multicast packet on the downlink to the unicast address of each of the wireless terminals in the target set at step 216. The method 200 can also suppress at step 218 the multicast packet on the downlink if the number of wireless terminals in the target set is zero at decision block 212.

One way to determine membership in a multicast group can include modifying IGMP or MLD signaling by the AP as further described in U.S. patent application Ser. No. 10/887,660, entitled “Downlink Multicast Method In Wireless Internet Protocol System,” filed on Jul. 9, 2004 by the Assignee hereto and further incorporated by reference herein. IGMP is the IETF IPv4 Internet Group Management Protocol and MLD is the IPv6 Multicast Listener Discovery protocol. These protocols are available as RFC 3376 and RFC 2710 at www.ietf.org. Below, a message is referred to as an IGMP Join message, a Join message or a Join. The official name for this message is Membership Report in IGMP and Multicast Listener Report in MLD.

IGMP is used between a subnet router such as multicast router 40 or a basestation or an AP and the group member hosts. With prior art use of IGMP or MLD, the router can learn whether there are 0 or any (>=1) member hosts on the subnet. A prior art router does not track whether there is more than one member on the subnet.

To indicate that at least one member of a multicast group is present, a member host sends an IGMP Join message. It sends the Join to the multicast address of the group. The Join multicast packet is transported on the wired subnet and hence the router and all other hosts will get a copy of the packet.

On reception of the IGMP Join the router adds the group to the list of groups for which there is at least one member on the subnet. Other members of the multicast group will also decode the packet sent to the multicast group address. They detect the Join and per IGMP or MLD protocol will not attempt to send a Join themselves. This reduces redundant Join messages.

Routers regularly poll for group membership by sending a General Membership Query. The default polling rate is 125 seconds. Hosts reply by sending a Membership Report after a random delay. They reply to the group multicast address. Again, other members will decode the report and those that do so do not have to send a report themselves.

When a member host leaves the subnet, it should send an IGMP or MLD Leave message. The Leave is sent to the group address. Since a prior art router does not count group members, it needs to check whether any group members are left. It can do so by sending a Specific Group Membership Query to the group address. The members, again, respond with a Membership Report on the group address after a random delay. This way normally only one member will respond. If no members respond to a membership query, the router will remove the group from the list of groups for which there is at least one member on the subnet. If a router has no more members on any subnet, it preferably uses the Multicast Routing Protocol to prune the distribution tree for the multicast group.

In a prior art system, when a WT host at an AP sends (multicasts) an IGMP Join or a Membership Report, the report will reach all other group members at all Access Points attached to the same subnet. This will have the effect that other members at other APs on the same subnet will not send a Join/Membership Report.

This method modifies the treatment of IGMP and MLD multicast packets in the APs 30-32 shown in FIG. 1. Using this modification, the AP will learn which group members are present in a cell. This enables the AP to establish a target member set for a multicast group for that cell. The method modifies the treatment of IGMP Joins, IGMP Leaves and IGMP Membership Reports by the AP. The AP maintains a target member set or a list of member Identifiers (Ids) for each multicast group it serves. The IDs preferably are unicast layer 2 (MAC) addresses but can also be or unicast layer 3 (IP) addresses or other unique identifiers. The AP executes the method when it receives a multicast packet for the multicast group from a WT on the uplink. To retain proper multicast distribution, regardless of the outcome of the method, the AP will forward the packet towards the wired infrastructure, if so required by prior art rules or Multicast Routing Protocols. The AP determines whether a received multicast packet is an IGMP Join/Leave or a Membership Report. If so, the AP does not transmit, or inhibits the transmission of the packet on the downlink. As a result, no other group member WTs will receive the Join message and, hence, per IGMP/MLD protocol all group members will send a Join. Similarly, all member WTs will also send a Membership Report in response to a Membership Query. Also, if it is an IGMP Join, IGMP Leave or Membership Report, the AP adjusts a target member set for the multicast group. For a Join or a Membership Report from a WT that is not yet in the target set, the AP adds the WT to the target set. The AP captures the ID of the member and adds the ID to a list, preferably storing the unicast layer 2 address of the member. For a Leave, the AP removes the WT from the target set. To deal with reports, the AP may clear the target set at the time it sends a Membership Query and add WTs back into the set as it receives Membership Reports, this way adding all members and capturing identities of all members.

When the AP receives a Leave, the AP may opt not to send a new membership query as prescribed by the IGMP protocol. After all, it already has a complete list of all the members it is serving.

When implemented at an Access Point that is a switch connected to a common subnet, the IGMP Join, Leave or Membership Report messages can come from the uplink from a local WT or from a WT at an other AP via the common subnet. In this case the AP will also inhibit the transmission of the packet on the downlink.

With further reference to FIGS. 2 and 3, the method 200 can further join a multicast distribution tree (at step 220) for the multicast group by the access point in response to the detecting (at step 204) of the session setup request for the multicast session. The access point can generate at step 222 a message for joining a multicast group in response to the detecting of the session setup request for the multicast session. The AP may use the protocol independent-sparse mode method or an equivalent method or message for joining a multicast group. At step 226, the method 200 can also store multicast group member sets for each wireless terminal in the plurality of wireless terminals served by the access point. At step 228 and with further references to FIG. 1, the method can further forward the multicast group member sets for one or more wireless terminals to an adjacent access point (33) to enable a proactive joining by the adjacent access point to a multicast distribution tree for the multicast group of the access point. The proactive joining can occur in response to a receipt by the adjacent access point 33 of a location update from a wireless terminal (14′) in a multicast group member set. The location update is understood to be any message by which the WT announces its desire to receive services from the adjacent access point. This method facilitates ‘seamless mobility’ for a target wireless terminal (14) that participates in a multicast session. When the target wireless terminal (14′) moves from the access point (32) to the adjacent access point (33) while receiving data packets belonging to a multicast session, the adjacent access point 33 can join the multicast distribution tree as soon as it has detected the presence of the target wireless terminal (14′) using link 25. Thus, the adjacent access point 33 can receive multicast packets for the target WT (14′) before the WT has explicitly requested the adjacent access point to do so, for example by sending a IGMP Membership Report or a MLD Multicast Listener Report. The adjacent access point may further start to transmit multicast packets to the target WT before the WT has requested the adjacent access point to do so. For such transmissions, the adjacent access point may use multicast, or unicast.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of sending a multicast packet in a wireless system having at least one access point serving a plurality of wireless terminals that are members of a multicast group, comprising the steps of:
collecting at the access point, a member set representing members of the multicast group that are being served, the member set including a unicast address for each wireless terminal in the set among the plurality of wireless terminals;
receiving a multicast packet by the access point;
determining a target set of served wireless terminals that are members of the multicast group that will receive the multicast packet;
multicasting the multicast packet on a downlink from the access point to a multicast address if a number of wireless terminals in the target set is greater or equal to a threshold; and
unicasting a copy of the multicast packet on the downlink to the unicast address of each of the wireless terminals in the target set, if the number of wireless terminals in the target set is below the threshold.

2. The method of claim 1, wherein the method further comprises the step of suppressing the multicast packet on the downlink if the number of wireless terminals in the target set is zero.

3. The method of claim 1, wherein the step of collecting comprises detecting by the access point a session setup request for a multicast session directed to a member of the multicast group.

4. The method of claim 3, further comprising the step of joining a multicast distribution tree for the multicast group by the access point in response to the detecting of the session setup request for the multicast session.

5. The method of claim 4, wherein the access point generates a protocol independent-sparse mode message for joining a multicast group in response to the detecting of the session setup request for the multicast session.

6. The method of claim 1, wherein the method further comprises the step of determining membership in the multicast group by modifying an Internet Group Management Protocol signal or by modifying a Multicast Listener Discovery protocol signal.

7. The method of claim 1, wherein the method further comprises the step of forwarding the multicast group member sets representing members of the multicast group that are being served to an adjacent access point to enable a proactive joining by the adjacent access point to a multicast distribution tree for the multicast group.

8. The method of claim 7, wherein the proactive joining occurs in response to a receipt by the access point of a location update from a wireless terminal in the target set.

9. The method of claim 1, wherein the step of determining the target set depends on whether the multicast packet is received from a member in the member set.

10. An access point serving a plurality of wireless terminals that are members of a multicast group, comprising:
a wireless transceiver;
a processor coupled to the wireless transceiver, wherein the processor is programmed to:
collect at the access point, a member set representing members of the multicast group that are being served, the member set including a unicast address for each wireless terminal in the set among the plurality of wireless terminals;
receive a multicast packet by the access point;
determine a target set of served wireless terminals that are members of the multicast group that will receive the multicast packet;
multicast the multicast packet on a downlink from the access point to a multicast address if a number of wireless terminals in the target set is greater or equal to a threshold; and
unicast a copy of the multicast packet on the downlink to the unicast address of each of the wireless terminals in the target set, if the number of wireless terminals in the target set is below the threshold.

11. The access point of claim 10, wherein the processor is further programmed to suppress the multicast packet on the downlink if the number of wireless terminals in the target set is zero.

12. The access point of claim 10, wherein the processor is programmed to collect by detecting a session setup request for a multicast session directed to a member of the multicast group.

13. The access point of claim 12, wherein the processor is further programmed to join a multicast distribution tree for the multicast group by the access point in response to the detecting of the session setup request for the multicast session.

14. The access point of claim 13, wherein the access point generates a protocol independent-sparse mode message for joining a multicast group in response to the detecting of the session setup request for the multicast session.

15. The access point of claim 10, wherein the processor is further programmed to determine membership in the multicast group by modifying an Internet Group Management Protocol signal or by modifying a Multicast Listener Discovery protocol signal

16. The access point of claim 10, wherein the processor is further programmed to forward the multicast group member set representing members of the multicast group that are being served to an adjacent access point to enable a proactive joining by the adjacent access point to a multicast distribution tree for the multicast group in response to a receipt by the access point of a location update from a wireless terminal in the target set.

17. The access point of claim 10, wherein the processor is further programmed to determine the target set of served wireless terminals that are members of the multicast group that will receive the multicast packet based on whether the multicast packet is received from a wireless terminal source or a network source.

18. A machine-readable storage, having stored thereon a computer program having a plurality of code sections executable by a machine for causing the machine to perform the steps of.
collecting a member set representing members of a multicast group that are being served by an access point, the member set including a unicast address for each wireless terminal in the set among a plurality of wireless terminals;
receiving a multicast packet by the access point;
determining a target set of served wireless terminals that are members of the multicast group that will receive the multicast packet;
multicasting the multicast packet on a downlink from the access point to a multicast address if a number of wireless terminals in the target set is greater or equal to a threshold; and
unicasting a copy of the multicast packet on the downlink to the unicast address of each of the wireless terminals in the target set, if the number of wireless terminals in the target set is above zero and below the threshold.

19. The machine-readable storage of claim 18, wherein the machine-readable storage is further programmed to collect the member set by detecting a session setup request for a multicast session directed to a member of the multicast group and to join a multicast distribution tree for the multicast group by the access point in response to the detecting of the session setup request for the multicast session.

20. The machine-readable storage of claim 19, wherein the machine-readable storage is further programmed to suppress the multicast packet on a downlink from the access point to a wireless terminal if the number of wireless terminals in the target set is zero.
